(19) United States
(12) Patent Application Publication
(10) Pub. No.: US 2017/0232482 A1
(43) Pub. Date: Aug. 17, 2017

(54) SPRAY GUN FOR A HIGH-PRESSURE CLEANING APPLIANCE

(71) Applicant: Alfred Kärcher GmbH & Co. KG, Winnenden (DE)

(72) Inventors: Vitali Fischer, Backnang (DE); Manuel Berroth, Lorch (DE)

(21) Appl. No.: 15/581,570

(22) Filed: Apr. 28, 2017

Related U.S. Application Data
(63) Continuation of application No. PCT/EP2015/072139, filed on Sep. 25, 2015.

(30) Foreign Application Priority Data
Oct. 30, 2014 (DE) 10 2014 115 789.3

(51) Int. Cl. B08B 3/02; B05B 1/30; B05B 7/04; B05B 12/00

(52) U.S. Cl. CPC B08B 3/026; B05B 12/008; B05B 1/3046; B05B 12/002; B05B 7/0408

(57) ABSTRACT

A spray gun for a high-pressure cleaning appliance is provided, with a gun casing, in which is arranged a valve, which has a through duct which extends from a valve inlet to a valve outlet, and has a closure body which, in a closed position, bears in a fluid-tight manner against a valve seat and which is adapted to be moved, with the aid of a hand lever mechanically coupled to the closure body, into an open position spaced apart from the valve seat, and with an electric apparatus which has an electric display device and at least one battery. The electric apparatus has an electric casing which is sealed against sprayed water and forms a sub-unit adapted to be handled independently, wherein all of the current-carrying components of the spray gun are arranged in the electric casing and are separated galvanically from the remaining components of the spray gun.

### CROSS-REFERENCE TO RELATED APPLICATIONS

This application is a continuation of international application number PCT/EP2015/072139 filed on Sep. 25, 2015 and claims the benefit of German application number 10 2014 115 789.3 filed on Oct. 30, 2014, which are each incorporated herein by reference in their entirety and for all purposes.

### BACKGROUND OF THE INVENTION

The invention relates to a spray gun for a high-pressure cleaning appliance, with a gun casing, in which there is arranged a valve, wherein the valve has a through duct which extends from a valve inlet to a valve outlet, and wherein the valve has a closure body which, in a closed position, bears in a fluid-tight manner against a valve seat and interrupts a flow connection from the valve inlet to the valve outlet and which can be moved, with the aid of a hand lever mechanically coupled to the closure body, into an open position spaced apart from the valve seat, and with an electric apparatus which has an electric display device and at least one battery.

With the aid of such spray guns, the discharge of fluid that has been put under pressure by a high-pressure cleaning appliance can be controlled. For example a pressure hose can be connected to the valve inlet, via which hose fluid under pressure can be supplied to the spray gun, and the valve outlet can be connected to a spray lance and/or spray nozzle, via which the fluid can be discharged. To control the fluid discharge, the user has the possibility to move the closure body of the valve with the aid of the hand lever. In a closed position the closure body bears in a fluid-tight manner against a valve seat and thereby interrupts the flow connection between the valve inlet and the valve outlet. In an open position the closure body assumes a position spaced apart from the valve seat and thereby frees the flow connection between the valve inlet and the valve outlet.

Spray guns can also comprise an electric apparatus having an electric display device and at least one battery which provides the electric energy necessary for the operation of the electric apparatus. On the display device, there can be displayed to the user, for example, information that relates to the operation of the spray gun and/or the high-pressure cleaning appliance and/or a spray nozzle or spray lance, in particular an indication of the pressure of the fluid and/or the flow rate of the fluid and/or of the type of spray nozzle or spray lance used, which is connected to the valve outlet.

A spray gun of the aforementioned type is known from WO 2007/101599 A1. The known spray gun has an electric control apparatus and a display device in the form of several light emitting diodes and a display.

The object of the present invention is to refine a spray gun of the aforementioned type such that it can be produced and assembled in a cost-effective manner, is insensitive to disturbances and is maintenance-friendly.

### SUMMARY OF THE INVENTION

This object is achieved, with a spray gun of the type in question, according to the invention in that the electric apparatus has an electric casing which is sealed against sprayed water and forms a sub-unit which can be handled independently, wherein all of the current-carrying components of the spray gun are arranged in the electric casing and are separated galvanically from the remaining components of the spray gun.

The invention incorporates the idea that the production and assembly of the spray gun can be simplified and the sensitivity to disturbances can be reduced by the electric apparatus forming a sub-unit which can be handled independently and has all of the current-carrying components of the spray gun. These current-carrying components are surrounded by an electric casing which is sealed against sprayed water and separated galvanically from the remaining components of the spray gun. The complete electric apparatus can thereby be preassembled separately from the remaining components of the spray gun and can then be put together with the gun casing. Through the use of the electric casing sealed against sprayed water it can be ensured in a structurally simple manner that the current-carrying components of the spray gun do not come into contact with fluid which is discharged from the spray gun. The components of the spray gun which are arranged outside the electric casing are not current-carrying and therefore cannot interfere with the operation of the electric apparatus on contact with the fluid. The complete electric apparatus can be electrically tested for functioning prior to its assembly.

The electric apparatus may have, for example, a battery compartment, into which the at least one battery can be inserted and which has terminals for the battery, the terminals being electrically connected to at least one rigid printed circuit board of the electric apparatus on which current-carrying components and the display device are arranged. The electric connection between the terminals and the at least one rigid printed circuit board can be carried out, for example, via cables or via flexible printed circuit boards or flexible conductor tracks which are arranged in the electric casing and therefore protected against sprayed water.

The battery compartment favorably has a cover which can be removed by the user to replace the at least one battery.

In an advantageous embodiment of the invention, the electric casing is releasably mechanically connectable to the gun casing. For example, provision may be made for the electric casing to be latchable and/or screwable to the gun casing. This facilitates the assembly of the spray gun.

It is advantageous when the electric apparatus has a standby mode and a usable operating mode, wherein the energy consumption of the electric apparatus in the standby mode is lower than in the usable operating mode, and wherein the usable operating mode is activatable by the user and when the spray gun is not in use the electric apparatus changes automatically into the standby mode at the latest after a predetermined period of time has elapsed. Such a configuration makes it possible to keep the energy consumption and thus also the maintenance requirement of the spray gun low. As long as the spray gun is not being used by user, the electric apparatus is in an energy-saving standby mode. In this case, provision may be made in particular for the electric display device to be switched off in the standby mode. When the user puts the spray gun into operation, he activates the usable operating mode in which all the functions of the electric apparatus are available to the user and in particular the display device is supplied with energy by the at least one battery.

To activate the usable operating mode, in an advantageous embodiment the spray gun has at least one activation member which can be moved by the user. A movement of the activation member signals to the electric apparatus that the spray gun is being put into use and a change from the standby mode into the usable operating mode is to take place. The usable operating mode is then maintained during operation of the spray gun. When the spray gun is put out of operation again, then the electric unit automatically changes into the standby mode at the latest after a predetermined period of time of time has elapsed. The actual usable function of the electric apparatus is thus only activated when the user activates the usable operating mode by moving the activation member.

The at least one activation member may be configured, for example, in the form of a sensor which detects a movement of the entire spray gun. In particular, the activation member may be configured in the form of an acceleration sensor.

Alternatively or additionally provision may be made for the at least one activation member to be configured in the form of a user-actuatable operating element, for example a button or a switch of the electric apparatus.

It is particularly advantageous when at least one activation member is arranged outside the electric casing in the gun casing and is movable back and forth between a rest position and an activation position, wherein the usable operating mode is wirelessly activatable by moving the activation member from the rest position into the activation position. In such a configuration, at least one activation member is arranged outside the electric casing and separated galvanically from the electric apparatus. The activation member can be moved back and forth between a rest position and an activation position, wherein a movement of the activation member from the rest position into the activation position results in the usable operating mode of the electric apparatus being wireless activated.

Provision may be made, for example, for the activation member arranged outside the electric casing to be wirelessly coupled in its activation position to a switching or sensor element of the electric apparatus and for the coupling to be interrupted in the rest position of the activation member. If there is a coupling between the activation member and the switching or sensor element, the usable operating mode of the electric apparatus can be activated, if there is no coupling between the activation member and the switching or sensor element, the usable operating mode cannot be activated by the activation member arranged outside the electric casing.

In an advantageous configuration of the invention, the usable operating mode is only active when the at least one activation member is in its activation position. If this activation member is in its rest position, in such a configuration of the invention, the standby mode is active. The usable operating mode is switched off when the activation member arranged outside the electric casing leaves its activation position. The energy consumption of the electric apparatus can thereby be kept particularly low.

Alternatively, provision may be made for the usable operating mode, after a change of the activation member from the activation position into the rest position, to be still maintained until a predetermined period of time has elapsed. When the activation member is in its activation position, the usable operating mode is active. When the activation member leaves its activation position, in such a configuration of the invention the usable operating mode initially remains active until a predetermined period of time has elapsed, which may be for example a few seconds or a few minutes. After the predetermined period of time has elapsed, then the electric apparatus automatically changes into the standby mode.

In an advantageous configuration of the spray gun according to the invention, the activation member arranged outside the electric casing is coupled to the hand lever. For discharging fluid, the user moves the hand lever, so that the closure body of the valve changes into its open position. When the activation member is coupled to the hand lever, it is possible with the change of the closure body into the open position also for a change from the standby mode into the usable operating mode to take place owing to the fact that a movement of the hand lever also results in a movement of the activation member from the rest position into the activation position. As long as the user actuates the hand lever, the activation member remains in its activation position, so that the electric apparatus maintains its usable operating mode. When the hand lever is released again by the user, the closure body of the valve assumes its closed position, and thus interrupts the flow connection between the valve inlet and the valve outlet, and at the same time the activation member changes into its rest position. The change of the activation member into the rest position then results in the electric apparatus changing into the standby mode, where appropriate after a predetermined period of time has elapsed.

In a structurally particularly simple configuration the activation member arranged outside the electric casing is rigidly connected to the hand lever. A movement of the hand lever thus also results in a movement of the activation member, without requiring additional mechanical transmission elements to be used.

Provision may be made, for example, for the activation member arranged outside the electric casing and the hand lever to be integrally connected to one another. The activation member and the hand lever can, in particular, form a one-piece plastic molded part.

As already mentioned, provision may be made for the activation member arranged outside the electric casing to be wirelessly coupled in its activation position to a switching or sensor element of the electric apparatus. Favorably, the activation member is coupled in the activation position, for example, magnetically, inductively, capacitively, optically, piezo-electrically or electromagnetically to the switching or sensor element.

Provision may be made, for example, for a mechanical pressure to be exerted on the electric casing with the aid of the activation member arranged outside the electric casing, which results in an electric voltage for activation of the usable operating mode being induced by a piezoelectric element arranged in the electric casing.

It is particularly advantageous when the activation member arranged outside the electric casing is a permanent magnet and the switching or sensor element of the electric apparatus is magnetic field-sensitive. A movement of the activation member from the rest position into the activation position in such a configuration of the invention results in an approach of the permanent magnet to the magnetic field-sensitive switching or sensor element, so that the field strength of the magnetic field provided by the permanent magnet is increased in the region of the magnetic field-sensitive switching or sensor element. The magnetic field can thereby be detected by the switching or sensor element, and the usable operating mode can thereby be activated. When the activation member is moved from the activation position into the rest position, this results in an increase of the distance between the permanent magnet and the magnetic field-sensitive switching or sensor element, so that the field strength of the magnetic field provided by the permanent magnet decreases at the location of the switching or sensor element, and this reduction in field strength can be detected by the switching or sensor element, so that subsequently, where appropriate after a predetermined period of time has elapsed, the usable operating mode is terminated automatically by the electric apparatus and a change into the standby mode takes place.

In an advantageous configuration of the invention, a reed switch is used as the magnetic field-sensitive switching element. By a movement of the activation member arranged outside the electric casing, the switching state of the reed switch can be altered, and due to such an alteration of the switching state a change from the standby mode into the usable operating mode can take place.

Alternatively or additionally to an activation member arranged outside the electric casing, at least one activation member arranged within the electric casing can also be used, in particular at least one activation element configured as a manually actuatable input element of the electric apparatus.

In an advantageous configuration of the spray gun according to the invention, the electric apparatus has at least two manually actuatable input elements which each form an activation member. By an actuation of one of the input elements a change can thus take place from the standby mode into the usable operating mode of the electric apparatus. This gives the user the option of activating the usable operating mode without having to actuate the hand lever to do so. The usable operating mode can thus be activated without simultaneously discharging fluid from the spray gun.

A particularly low energy consumption is achieved in a preferred configuration of the invention by the fact that the standby mode is a rest state in which the electric apparatus does not consume energy. In such a configuration, the electric apparatus is completely switched off in the standby mode.

Provision may be made, for example, for the transmission of electric energy from the battery to all current consumers of the electric apparatus to be interrupted in the standby mode. In such a configuration the circuit between the battery and the current consumers of the electric apparatus is interrupted in the standby mode and the circuit is closed when the usable operating mode is activated by the user. For example, provision may be made for the circuit between the battery and the current consumers to be closed by an actuation of an input element of the electric apparatus and/or by a movement of an activation member arranged outside the electric apparatus and preferably coupled to the hand lever.

As mentioned at the outset, provision may be made for the pressure of the fluid to be displayed on the electric display device. For this purpose, in a configuration of the invention which is particularly maintenance-friendly and insensitive to disturbances, provision is made for the spray gun to have a pressure detecting device for detecting the fluid pressure prevailing downstream of the valve seat in the through duct, wherein the pressure detecting device is arranged outside the electric casing in the gun casing and is wirelessly coupled to a sensor element of the electric apparatus arranged in the electric casing. By means of the pressure detecting device, the fluid pressure can be detected. A signal corresponding to the fluid pressure can be wirelessly inputted into the electric apparatus without in doing so a galvanic connection between the pressure detecting device and the electric apparatus having to be present. In such a configuration too, all current-carrying components of the spray gun can thus be arranged inside the electric casing sealed against sprayed water, and yet a signal corresponding to the pressure of the fluid can still be displayed on the display device.

The pressure detecting device is favorably magnetically, inductively, capacitively, optically, piezo-electrically or electromagnetically coupled to the sensor element.

For example, provision may be made for the sensor element to form a resonant circuit which can be detuned from the pressure detecting device in dependence on the fluid pressure prevailing downstream of the valve seat.

Alternatively or additionally, provision may be made, for example, for the pressure detecting device to be associated with a light-sensitive sensor element which can be acted upon by a light beam whose intensity depends on the fluid pressure prevailing downstream of the valve seat. For this purpose, the electric apparatus may, for example, have a light barrier having a transmitter and a receiver which are arranged opposite each other on a wall of the electric casing, and outside the electric casing an element which attenuates the intensity of the light beam can dip into the region between the transmitter and the receiver in dependence on the aforementioned fluid pressure, and thereby attenuate the intensity of the light beam depending on the pressure. The attenuating element may be movably mounted outside the electric casing in the gun casing and configured, for example, wedge-shaped.

Provision may be made for the sensor element associated with the pressure detection to be magnetic field-sensitive and for the pressure detecting device to comprise a permanent magnet whose spacing from the sensor element is variable in dependence on the fluid pressure prevailing downstream of the valve seat in the through duct. The permanent magnet of the pressure detecting device can be arranged outside the electric casing in the gun casing and, starting from a position of maximum spacing from the associated sensor, can be moved into a position of proximity to the associated sensor, in dependence on the fluid pressure prevailing downstream of the valve seat. Depending on the spacing of the permanent magnet from the sensor element, the field strength of the magnetic field provided by the permanent magnet at the location of the sensor element has a larger or smaller value that represents a measure of the said fluid pressure. The electric apparatus may comprise an evaluating unit, in particular a microcontroller, to which the magnetic field-sensitive sensor element can provide a signal corresponding to the fluid pressure prevailing downstream of the valve seat. The signal can be evaluated by the evaluating device, and this in turn makes it possible to display the fluid pressure on the display device.

In a preferred configuration of the invention, the permanent magnet of the pressure detecting device is rigidly connected to a push part, which is mounted displaceably against a spring-elastic restoring force in dependence on the fluid pressure in a guide part prevailing downstream of the valve seat in the through duct.

The guide part is favorably held on a valve casing having the through duct leading from the valve inlet to the valve outlet.

It is favorable when the guide part is releasably connectable to the valve casing. This facilitates the assembly of the spray gun.

The push part is advantageously connected to a measuring member, which can be acted upon by the fluid pressure prevailing downstream of the valve seat in the through duct. The measuring member may, for example, be in the form of a measuring rod which is held displaceably in a measuring duct of the valve and is surrounded by a sealing element, for example a sealing ring, wherein the measuring duct opens into the through duct of the valve and the front side, facing the through duct, of the measuring rod can be acted upon by the pressure prevailing in the through duct downstream of the valve seat. The measuring rod can be rigidly connected to a push part configured, for example, piston-like, to which the permanent magnet is fixed. A restoring spring can bear against a rear side, facing away from the measuring rod, of the push part, so that the push part can be moved against the action of the restoring spring upon the application of fluid pressure.

As already mentioned, it is favorable when a signal corresponding to the fluid pressure prevailing downstream of the valve seat can be visually displayed on the display device. In this case provision may be made for one of a plurality of pressure ranges to be visually displayed on the display device in dependence on the pressure prevailing downstream of the valve seat in the through duct. Depending on which pressure range a fluid pressure currently prevailing downstream of the valve seat comes under, the corresponding pressure range can be visually displayed to the user on the display device.

It is particularly advantageous when at least one recommendation, dependent on the pressure of the fluid, for a spray nozzle can be displayed to the user on the display device. The spray gun can have a gun outlet on which a connecting element is arranged for releasable connection of the spray gun to a spray nozzle. The spray nozzle can be arranged for example at the free end of a jet pipe which can be connected to the gun outlet. In this case, spray nozzles in the form of fan nozzles are known, in which pressurized fluid can be discharged fan-shaped. Also spray nozzles in the form of so-called rotary nozzles are known, in which the pressurized fluid is discharged in the form of a point jet circulating on a cone envelope. Finally, spray nozzles are known which have a relatively large nozzle outlet and are used when a cleaning chemical is admixed with a pressurized fluid, in particular pressurized water. The user thus has the possibility in many cases to connect different spray nozzles to the spray gun according to the invention. However, the spray nozzles are often not suitable for all pressure ranges. For the function of a rotary nozzle, it is necessary, for example, for the fluid to have a relatively high pressure. It is therefore advantageous when the user receives on the display device a recommendation for at least one spray nozzle, the recommendation being dependent on the pressure of the fluid. If, for example, there is a low pressure present, a recommendation can be displayed to the user on the display device for a nozzle which is used when a cleaning chemical is admixed with the fluid, whereas at a very high pressure a recommendation for a rotary nozzle or a fan nozzle is shown on the display device.

In a structurally particularly simple and economically producible embodiment of the spray gun according to the invention, the display device comprises a plurality of visual display elements, in particular a plurality of light emitting diodes. Depending on which pressure range is present, different light emitting diodes or a different number of light emitting diodes can be activated.

Provision may also be made for the display device to have, for example, a liquid crystal display.

It is particularly advantageous when the display device forms a graphical user interface. The display device may form a touch-sensitive screen.

In a preferred configuration of the invention, the electric apparatus has a transmitting device for wireless transmission of signals from the electric apparatus to the high-pressure cleaning appliance. Such a configuration gives the user the possibility, in particular, to transmit control signals wirelessly from the spray gun to the high-pressure cleaning appliance. For example, the user can on the display device select one of a plurality of predetermined pressure ranges and a signal corresponding to the selected range can then be transmitted by the transmitting device wirelessly to the high-pressure cleaning appliance, which has a corresponding receiving device. On the high-pressure cleaning appliance a pressure, corresponding to the selected pressure range, of the fluid discharged from the high-pressure cleaning appliance can be set by means of a control device by, for example, changing the pumping capacity of the high-pressure cleaning appliance or opening a bypass valve of the high-pressure cleaning appliance, which frees a flow path within the high-pressure cleaning appliance from a pressure outlet to a suction inlet.

It is advantageous when the electric apparatus has a receiving device for wireless transmission of signals from the high-pressure cleaning appliance to the electric apparatus. This makes it possible to transmit, for example, operating parameters of the high-pressure cleaning appliance wirelessly to the spray gun and display them on the display device of the electric unit. In particular, the high-pressure cleaning appliance can have a pressure sensor which detects the pressure of the fluid prevailing at the pressure outlet of the high-pressure cleaning appliance, and a pressure signal corresponding to the detected pressure can be wirelessly transmitted to the electric apparatus of the spray gun and visually displayed on the display device.

In a particularly preferred configuration of the invention, the electric unit has a combination of a transmitting device and a receiving device in the form of a transceiver. This makes it possible to create a bidirectional communication channel between the spray gun and the high-pressure cleaning appliance, so that signals can be wirelessly transmitted both from the electric apparatus to the high-pressure cleaning appliance and from the high-pressure cleaning appliance to the electric apparatus. This makes it possible for the user, for example, to select on the display device a desired pressure range, so that a corresponding control signal can be transmitted from the electric apparatus to the high-pressure cleaning appliance, then a measuring signal can be transmitted from the high-pressure cleaning appliance to the electric apparatus, the measuring signal corresponding to the fluid pressure currently prevailing at the pressure outlet of the high-pressure cleaning appliance, and a pressure range which the currently prevailing fluid pressure comes under, can then be displayed to the user on the display device of the electric apparatus.

In an advantageous configuration of the spray gun according to the invention, on the display device a plurality of cleaning parameter ranges can be visually displayed and a desired cleaning parameter range can be selected by the user, wherein the desired cleaning parameter range can be wirelessly transmitted from the electric apparatus to the high-pressure cleaning appliance. As already mentioned, in such a configuration of the invention the user can select on the display device, for example, a desired pressure range, which is then transmitted to the high-pressure cleaning appliance. Even ranges with a different mixing ratio between the pressurized fluid and an admixed cleaning chemical can be favorably displayed as cleaning parameter ranges on the display device.

It is favorable when the electric apparatus has at least one input element for inputting and/or selecting a control command, in particular a control command which corresponds to the setting of a desired cleaning parameter range.

The input element is advantageously configured in the form of a selection element, with which the user can select one of a plurality of predetermined cleaning parameter ranges.

The electric apparatus has in an advantageous configuration of the invention a rigid printed circuit board, on which the at least one input element and the electric display device are arranged, wherein the at least one input element is coupled to an operating element which has a user-operable interface, wherein the user interface is inclined to a plane which is defined by the display device. The arrangement of the display device and the at least one input member on the rigid printed circuit board makes it possible to keep the production costs of the electric apparatus low. When using the spray gun, the display device should be as clearly visible as possible for the user, and so it is favorable when the display device is inclined to a longitudinal axis of the spray gun only a little, because the spray gun is usually aligned approximately horizontally by the user and the user looks at the display device from above. Since the input elements are arranged together with the electric display device on the printed circuit board, the relatively small inclination of the display device to the longitudinal axis means that the input elements are also inclined to the longitudinal axis only a little. This makes their handling more difficult. According to the invention, therefore, the at least one input element is coupled to an operating element, the user interface of which is inclined to a plane defined by the display device. The user interface can therefore have a different inclination to the longitudinal axis than the display device, and this in turn facilitates the actuation thereof for the user. Despite the arrangement of the input elements and the display device on the same rigid printed circuit board, the display device can thus be easily seen by the user and the user interfaces of the operating elements can be actuated by the user in an ergonomically favorable manner.

Provision may be made, for example, for the at least one input element to be configured as a button which can be acted upon with an actuation force by an associated operating element. The button can be mounted directly on the printed circuit board, and therefore have the same orientation to the longitudinal axis of the spray gun as the display device, and by the provision of the associated operating element it can be actuated in an ergonomically favorable manner.

The at least one operating element is advantageously configured as a force diverting element which is movably mounted on the electric casing.

For example, provision may be made for the force diverting element to be configured as a tumbler.

It is particularly advantageous when the spray gun has a handle which can be gripped by the user, and when the at least one user interface is arranged at an upper end of the handle facing the display device. When using the spray gun, the handle can be gripped by the user with the hand, and as the at least one user interface is arranged at the upper end of the handle, the user can use his thumb to reach the user interface in a simple manner.

The following description of advantageous embodiments of the invention serves in conjunction with the drawings for further explanation.

### BRIEF DESCRIPTION OF THE DRAWINGS

FIG. 1 shows a schematic longitudinal sectional view of a first advantageous embodiment of a spray gun according to the invention;

FIG. 2 shows an enlarged partial sectional view of the spray gun of FIG. 1;

FIG. 3 shows a perspective view of a pressure detecting member of the spray gun of FIG. 1;

FIG. 4 shows a schematic block diagram of an electric apparatus of the spray gun of FIG. 1;

FIG. 5 shows an enlarged partial sectional view of a second advantageous embodiment of a spray gun according to the invention;

FIG. 6 shows a perspective view of an electric apparatus of the spray gun of FIG. 5 with the electric casing open;

FIG. 7 shows a simplified block diagram of the electric apparatus of FIG. 6.

### DETAILED DESCRIPTION OF THE INVENTION

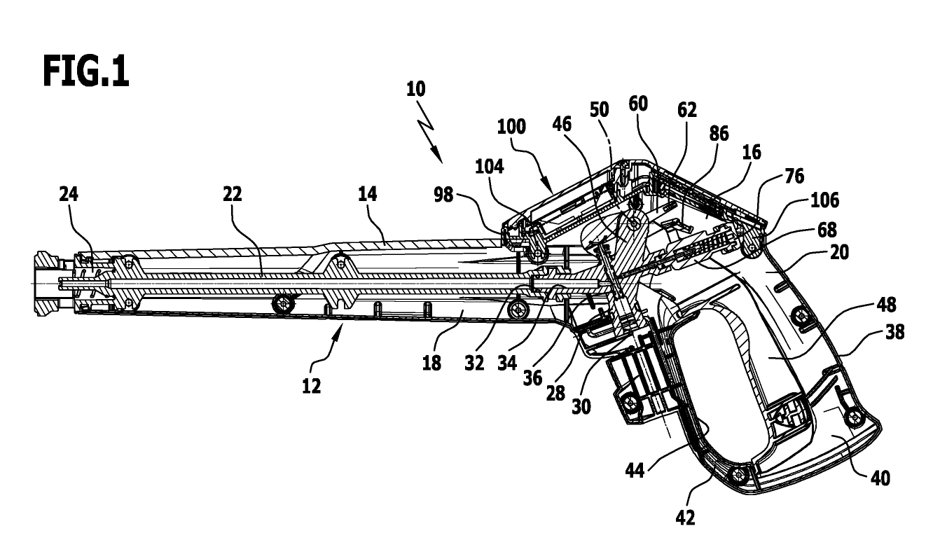

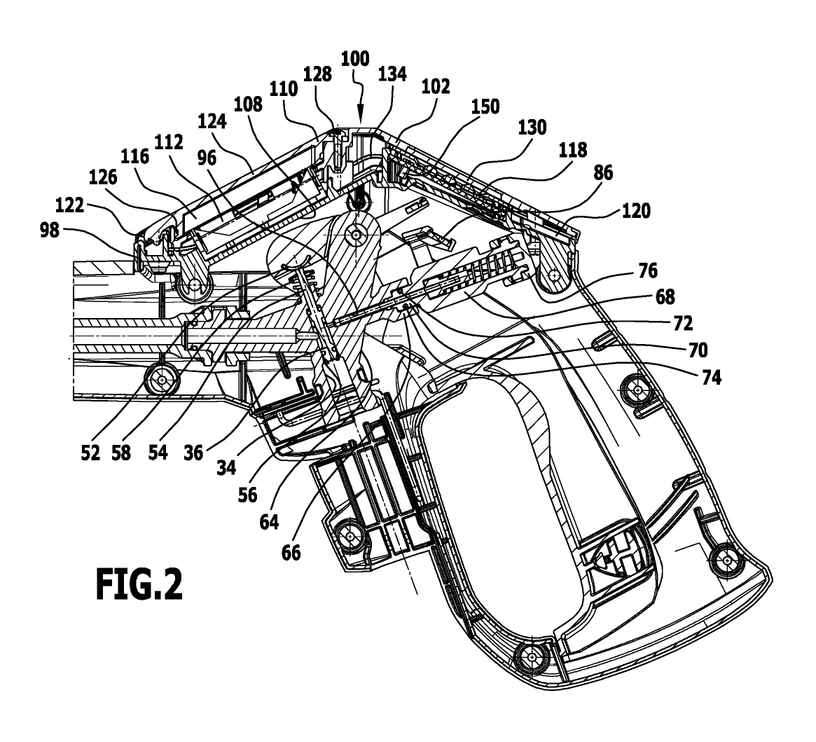

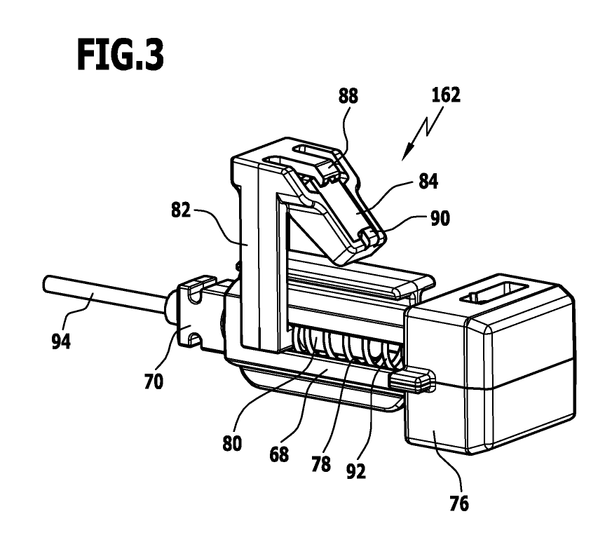

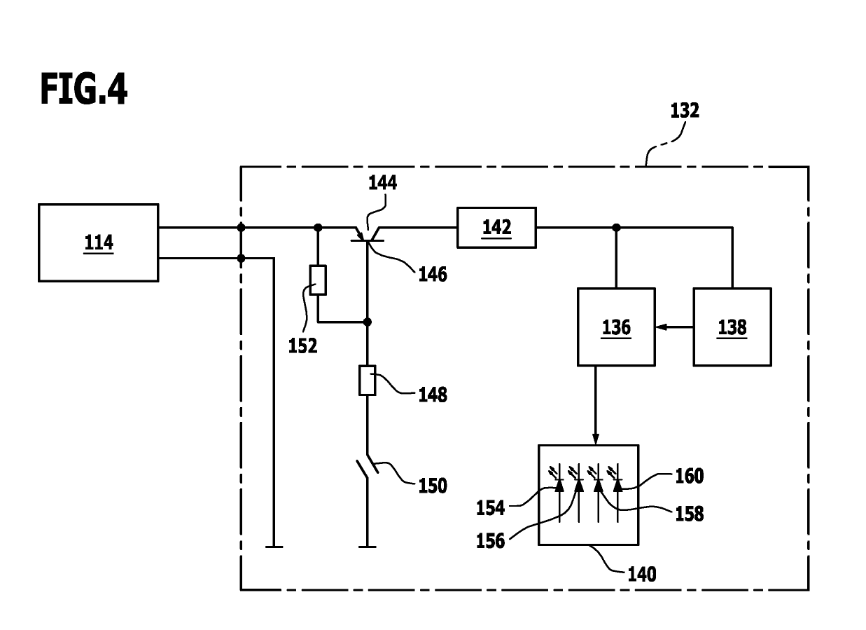

In FIGS. 1 to 4, a first advantageous embodiment of a spray gun according to the invention is schematically shown, which is designated overall by the reference symbol 10. The spray gun 10 comprises a gun casing 12 which is formed from a first casing half-shell 14 and a second casing half-shell, not shown in the drawing, and which has a central casing region 16 which is arranged between a front casing region 18 and a rear casing region 20. The front casing region 18 accommodates an outlet conduit 22 which is connected at its free end facing away from the central casing region 16 to a connecting device 24. With the aid of the connecting device 24 there can be connected to the outlet conduit 22 a spray nozzle or a spray lance.

The central casing region 16 accommodates a valve 26 with a valve casing 28 which has a valve inlet 30 and a valve outlet 32 and a through duct 34 which extends from the valve inlet 30 to the valve outlet 32 and in which a closure body 36 is displaceably held. To the valve outlet 32, the outlet conduit 22 is connected and to the valve inlet 30, a pressure hose can be connected in a manner known per se to a person skilled in the art, which is in flow connection with the pressure outlet of a high-pressure cleaning appliance. Via the pressure hose, the spray gun 10 can be provided with fluid, preferably water, which is put under pressure by the high-pressure cleaning appliance, and via the outlet conduit 22 the fluid can be discharged.

The rear casing region 20 forms a handle 38 which projects from the central casing region 16 and a guard bow 42 extends from the free end region 40 of the handle to the central casing region 16. The guard bow 42, the central casing region 16 and the handle 34 surround a handle aperture 44, into which the user can reach with his fingers when gripping the handle 38.

The valve casing 28 forms an arm 46 on which a hand lever 48 is pivotably mounted about a pivot axis 50. The hand lever 48 extends, at the front side of the handle 38 facing the guard bow 42, along as far as the free end region 40 of the handle 38. It can be pivoted by the user about the pivot axis 50 by the user gripping the handle 38 together with the hand lever 42 with his fingers.

At its end facing away from the handle aperture 44, the hand lever 48 carries an actuating element 52 which bears against a valve tappet 54. The valve tappet 54 is integrally connected to the closure body 36 of the valve 26. By pivoting of the hand lever 48 about the pivot axis 50, the valve tappet 54 can be moved back and forth together with the closure body 36 in the through duct 34 between a closed position shown in the drawing and an open position not shown in the drawing. In the closed position the closure body 36 bears in a fluid-tight manner against a valve seat 56, so that the flow connection between the valve inlet 30 and the valve outlet 32 is interrupted, and in an open position the closure body 36 is spaced from the valve seat 56 and thereby frees the flow connection between the valve inlet 30 and the valve outlet 32.

The valve tappet 54 is surrounded in the region between the actuating element 52 and an outer side of the valve casing 28 by a first restoring spring 58, which acts upon the hand lever 48 with a spring-elastic restoring force when the valve tappet 54 together with the closure body 36 is moved from its closed position to its open position by pivoting of the hand lever 48.

At the level of the pivot axis 50 the hand lever 48 is integrally connected to a pivot arm 60 which can be pivoted together with the hand lever 48 about the pivot axis 50 and carries at its free end an activation member in the form of a first permanent magnet 62. The importance of the first permanent magnet 62 will be explained in more detail below.

At the rear side 64, facing away from the closure body 36, of the arm 46 an accommodating sleeve 66 is formed, into which a guide cylinder 68 dips with an extension 70. By means of clamping pins 72, 74 the extension 70 is releasably held in the accommodating sleeve 66.

The guide cylinder 68 is configured hollow and is closed at its rear side facing away from the extension 70 by means of a plug 76. At two diametrically opposite longitudinal sides, the guide cylinder 68 has in each case a longitudinal slot, although only one of the longitudinal slots can be seen in the drawing and is designated by the reference symbol 78.

The guide cylinder 68 accommodates a piston-like push part 80 which is rigidly connected, via a holding arm 82 passing through the longitudinal slot 78 from the inside to the outside, to a holder 84 for a second permanent magnet 86. The second permanent magnet 86 is latched into the holder 84, the holder 84 having for this purpose two opposite, elastically deformable latching elements 88, 90.

The push part 80 is acted upon by a second restoring spring 92 with a spring-elastic restoring force. The second restoring spring 92 is arranged in the guide cylinder 68 on the side of the push part 80 facing away from the extension 70 and is supported at one end on the push part 80 and at the other end on the plug 76.

The push part 80 is rigidly connected to a measuring member in the form of a measuring rod 94 which passes through the extension 70 and dips into a measuring duct 96. The measuring duct 96 opens downstream of the valve seat 56 into the through duct 34, so that the front side of the measuring rod 94 facing the through duct 34 is acted upon by the pressure of the fluid prevailing downstream of the valve seat 56 and, together with the push part 80 and the second permanent magnet 86 fixed thereto via the holding arm 82, can be displaced against the spring-elastic restoring force of the second restoring spring 92.

Within the measuring duct 96 the measuring rod 94 is surrounded in the circumferential direction by a sealing element, preferably a sealing ring, not shown in the drawing to achieve a better overview, which ensures that fluid cannot escape from the valve casing 28 via the measuring duct 96.

The gun casing 12 forms in the central casing region 16, on the top side facing away from the valve inlet 30, a casing receptacle 98 which accommodates an electric apparatus 100. The electric apparatus 100 has an electric casing 102 which is sealed against sprayed water and is releasably connectable to the gun casing 12. The electric casing 102 for this purpose has a front connecting strap 104 and a rear connecting strap 106, which can be inserted between the casing half-shells of the gun casing 12 and through which can be passed connecting screws which are used for screwing on the two casing half-shells of the gun casing 12.

The electric casing 102 has a casing lower part 108 and a casing upper part 110 which are fluid-tightly connected to each other. The electric casing 102 forms a battery compartment 112, into which at least one rechargeable battery 114 can be inserted. The battery compartment 112 is arranged in a front casing half 116 of the electric casing 112. In addition, the electric casing 102 has an accommodating area 118 which is arranged in a rear casing half 120 of the electric casing 102. The front casing half 116 faces the front casing region 18 of the gun casing 12, and the rear casing half 120 of the electric casing 102 faces the handle 38 of the gun casing 12.

In order to allow access to the battery compartment 112, the casing upper part 110 in the front casing half 116 has a casing aperture 122 which can be fluid-tightly closed by a battery compartment cover 124. The battery compartment cover 124 bears fluid-tightly against the casing lower part 108 with the interposition of a sealing ring 126 and can be screwed by means of connecting screws 128 to the casing lower part 108.

In the region of the rear casing half 120, the casing upper part 110 of the electric casing 102 is of transparent design and forms a viewing window 130 sealed against sprayed water.

The accommodating region 118 accommodates a rigid printed circuit board 132, on which a multiplicity of current-carrying electric components are held, which are electrically connected via flexible conductor tracks 134 to the battery 114. The current-carrying electric components comprise a microcontroller 136 which is electrically connected to a magnetic field-sensitive sensor, in the illustrated exemplary embodiment to a Hall sensor 138, and to a display device 140. Electric energy can be provided to the microcontroller 136 and the Hall sensor 138 via a voltage transformer 142 and a switching transistor 144 by the battery 114. A control input 146 of the switching transistor 144 is connected via a first ohmic resistor 148 and a reed switch 150 to earth potential, and a second ohmic resistor 152 is connected in parallel with the base-emitter path of the switching transistor 144, via which the control input 146 of the switching transistor 144 is connected to the battery 114.

With the aid of the reed switch 150 and the switching transistor 144, the energy consumers of the electric apparatus 100 can be selectively disconnected from the battery 114 and connected to the battery 114. When the reed switch 150 is closed, a voltage drops via the two ohmic resistors 148, 152 connected in series. This has the result that the switching transistor 144 closes and thereby frees an electric connection between the voltage transformer 142 and the battery 114, so that the microcontroller 136, the Hall sensor 138 and the display device 140 can be supplied with electric energy. When the reed switch 150 assumes its open switching position, then no more electric current flows via the ohmic resistors 148 and 152 and the switching transistor 144 interrupts the electric connection between the battery 114 and the voltage transformer 142, so that the microcontroller 136, the Hall sensor 138 and the display device 140 cannot be provided with any more electric energy. The electric apparatus 100 thus has a usable operating mode, in which the reed switch 150 is closed and the energy consumers of the electric apparatus 100 are provided with electric energy. Furthermore, the electric apparatus 100 has a standby mode, in which the reed switch 150 is open and the energy consumers of the electric apparatus 100 are not supplied with electric energy. The standby mode forms a rest state in which the electric apparatus 100 consumes no electric energy at all.

The change from the standby mode into the usable operating mode is effected by closing the reed switch 150. The reed switch 150 is closed with the aid of the first permanent magnet 62, which forms an activation member arranged outside the electric casing 102 and movable back and forth by the user between a rest position and an activation position. In the rest position, the first permanent magnet 62 together with the free end of the pivot arm 60 assumes a position of maximum spacing from the reed switch 150, so that the field strength of the magnetic field provided by the first permanent magnet 62 prevailing at the location of the reed switch 150 is small. The rest position of the first permanent magnet 62 is present when the hand lever 48 rigidly connected to the first permanent magnet 62 undergoes no actuation by the user. When there is no actuation, the hand lever 48 is acted upon by the first restoring spring 58 with a spring-elastic restoring force, under the action of which the hand lever 48 dips into the handle aperture 44 and the first permanent magnet 62 assumes its rest position of maximum spacing from the reed switch 150. When the hand lever 48 is actuated by the user to free the flow path between the valve inlet 30 and the valve outlet 32, the first permanent magnet 62 is pivoted together with the pivot arm 60 into an activation position of maximum approach to the reed switch 150. In the activation position, the field strength of the magnetic field provided by the first permanent magnet 62 at the location of the reed switch 150 is sufficiently large so that the reed switch 150 changes into its closed switching position, and consequently the energy consumers of the electric apparatus 100 are supplied with energy via the switching transistor 144, and thus the usable operating mode of the electric apparatus 100 is activated.

An actuation of the hand lever 48 for freeing the flow connection between the valve inlet 30 and the valve outlet 32 thus has the result that the usable operating mode of the electric apparatus 100 is activated. The usable operating mode is maintained only as long as an actuation of the hand lever 48 takes place. When the user releases the hand lever 48 again, the electric apparatus 100 changes automatically into its standby mode, in which the electric apparatus 100 consumes no energy at all.

The display device 140 has, in the first advantageous embodiment of the invention illustrated in FIGS. 1 to 4, four light emitting diodes 154, 156, 158 and 160, which are mounted on the rigid printed circuit board 132. The light emitting diodes 154, 156, 158 and 160 are activated by the microcontroller 136 in dependence on the fluid pressure prevailing downstream of the valve seat 56. For this purpose, the measuring rod 94 forms in combination with the push part 80, the second restoring spring 92, the holding arm 82 and the second permanent magnet 86 and the Hall sensor 138, a pressure detecting device 162, by means of which the fluid pressure prevailing downstream of the valve seat 56 can be detected. In dependence on the fluid pressure mentioned, the second permanent magnet 86 approaches the Hall sensor 138, arranged in the electric casing 102, to a greater or lesser extent. The magnetic field provided by the second permanent magnet 86 can be detected by the Hall sensor 138 and a corresponding sensor signal can be evaluated by the microcontroller 136, which forms an evaluating device. Depending on the fluid pressure an activation of the light emitting diodes 154, 156, 158, 160 can then take place.

The light emitting diodes 154, 156, 158 and 160 provide the possibility of displaying a total of four different pressure ranges to the user. Depending on which of the pressure ranges the pressure currently prevailing downstream of the valve seat 56 in the through duct 34 comes under, the light emitting diode 154, 156, 158, 160 associated with the corresponding pressure range can be activated.

The electric apparatus 100 is separated galvanically from the remaining components of the spray gun 10. This facilitates the protection of current-carrying components from fluid, because all current-carrying components can be arranged in the electric casing 102 sealed against sprayed water, and electric contact elements via which the electric components arranged in the electric casing 102 are connected to components arranged outside the electric casing 102 can be omitted. To activate the usable operating mode the electric apparatus 100 is wirelessly and contactlessly connected to the activation member in the form of the first permanent magnet 62 arranged outside the electric casing 102, and for transmitting a signal corresponding to the fluid pressure currently prevailing downstream of the valve seat 56 in the through duct, the electric apparatus 100 is wirelessly and contactlessly connected to the second permanent magnet 86.

The current consumption of the electric apparatus 100 and therefore also its maintenance requirement is very low, since the electric apparatus 100 is in a current-consuming usable operating mode only when the user actuates the hand lever 48, otherwise the electric apparatus 100 is in a standby mode in which it consumes no energy.

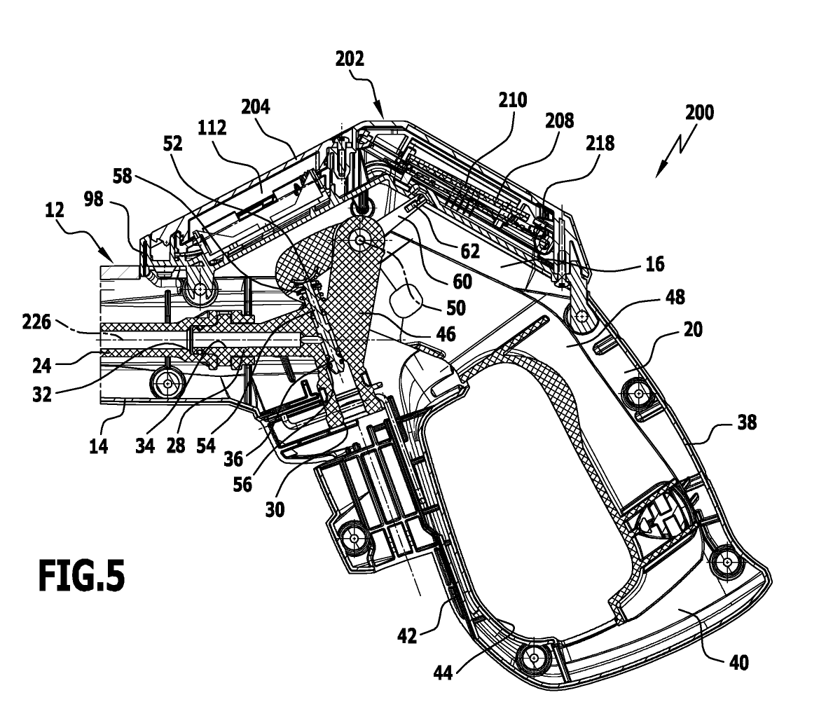

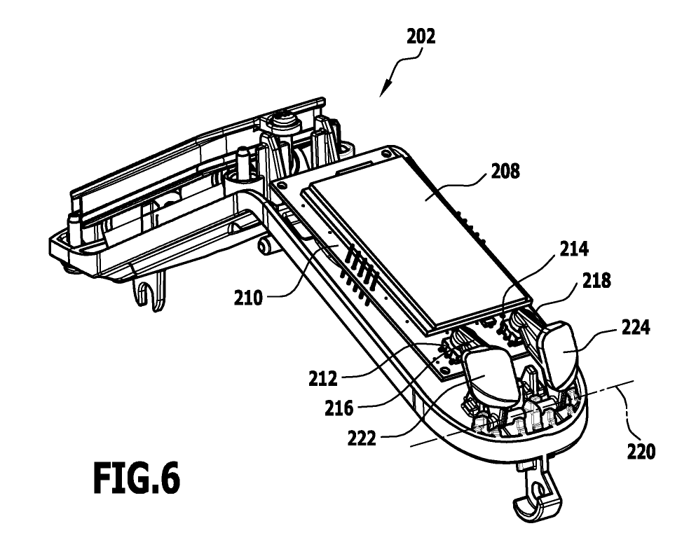

In FIGS. 5, 6 and 7, a second advantageous embodiment of a spray gun according to the invention is shown schematically and is designated overall by the reference symbol 200. The spray gun 200 is configured largely identically to the spray gun 10 explained with reference to FIGS. 1 to 4. For identical components, therefore, in FIGS. 5, 6 and 7 the same reference symbols are used as in FIGS. 1 to 4 and reference is made to the above explanations with respect to these components to avoid repetition.

The spray gun 200 has, in the same way as the spray gun 10, an activation member arranged outside an electric casing sealed against sprayed water in the form of a first permanent magnet 62, which on actuation of the hand lever 48 is pivotable from a rest position into an activation position to activate a usable operating mode of an electric apparatus 202. The electric apparatus 202 comprises, like the above-explained electric apparatus 100, an electric casing 204 sealed against sprayed water, in which all the current-carrying components of the spray gun 200 are arranged.

In contrast to the spray gun 10, the spray gun 200 has no pressure detecting device. Instead, the electric apparatus 202 comprises a combined transmitting and receiving device in the form of a transceiver 206, with the aid of which signals can be wirelessly transmitted bidirectionally, preferably by radio, between the electric apparatus 202 and the high-pressure cleaning appliance, to which the spray gun 200 is connected. This provides the possibility of using a pressure sensor to measure the pressure of the conveyed fluid in the high-pressure cleaning appliance and to transmit a corresponding signal from the high-pressure cleaning appliance to the electric apparatus 202. Control commands can be transmitted from the electric apparatus 202 to the high-pressure cleaning appliance for setting a specific pressure range, which the user can select on a display device 208, preferably on a liquid crystal display. The display device 208 is mounted on a rigid printed circuit board 210 of the electric apparatus 202. On the display device 208 different cleaning parameter ranges can, for example, be displayed graphically to the user, from which the user can select a desired cleaning parameter range, for example, a specific pressure range. Additionally or alternatively, other information can be displayed graphically on the display device 208. In particular, a recommendation for a certain spray nozzle which can be connected when there is a specific pressure of the fluid supplied to the spray gun 200 can be displayed graphically on the display device 208 to the user. If a spray nozzle for discharging a mixture of fluid and a cleaning chemical is connected to the spray gun 200, different mixing ratios of the cleaning chemical can also be displayed on the display device 208, from which the user can select a desired mixing ratio.

To select a specific cleaning parameter range, the electric apparatus 202 has two input elements in the form of two input keys 212, 214, which are mounted directly on the single rigid printed circuit board 210 of the electric apparatus 202. The input keys 212, 214 are each associated with an operating element in the form of a tumbler 216, 218. The tumblers 216, 218 axe mounted on the electric casing 204 pivotably about a common pivot axis 220. The two tumblers 216, 218 each have a user interface 222, 224 which is inclined to a plane which is defined by the display device 208. This facilitates operation of the electric apparatus for the user, because the display device 208 mounted on the rigid printed circuit board 210 can be inclined at a different angle to the longitudinal axis 226 of the spray gun 200 than the user interfaces 222, 224, by providing the tumblers 216, 218. The longitudinal axis 226 of the spray gun 200 is in this case predetermined by the longitudinal direction of the outlet conduit 22.

Provision may be made, for example, for the display device 208 together with the rigid printed circuit board 210 to be inclined at a significantly smaller angle to the longitudinal axis 226 than the user interfaces 222, 224. The inclination of the display device 208 to the longitudinal axis 226 may, for example, be 10 to 50°, preferably 30°, and the inclination of the user interfaces 222, 224 to the longitudinal axis 226 may, for example, be 60 to 80°, preferably 70°. This makes it easier for the user to read information displayed on the display device 208, and to operate the input keys 212, 214 by means of the tumblers 216, 218, because the user can view the display device 208 from above on use of the spray gun 200. With one hand he can grip the handle 38 of the spray gun 200, it being possible for him to actuate the hand lever 48 with his fingers and a desired user interface 222 or 224 with his thumb. The user interfaces 222, 224 are arranged for this purpose at the upper end of the handle 38 facing the rear casing half 120 of the electric casing 204. The spray gun 200 can thus be operated by the user with one hand and the user can easily read information on the display device 208.

The two input keys 212, 214 of the electric apparatus 202 have not only the function of inputting control commands of the electric apparatus 202, but in addition they form activation members which are arranged in the electric casing 204 and with the aid thereof a usable operating mode of the electric apparatus 202 can be activated. This gives the user of the spray gun 200 the option to activate a usable operating mode of the electric apparatus 202 selectively either by actuating the hand lever 48, as has already been explained in detail above with reference to the spray gun 10, or by actuating one of the user interfaces 222, 224 which are each coupled to an input key 212, 214.

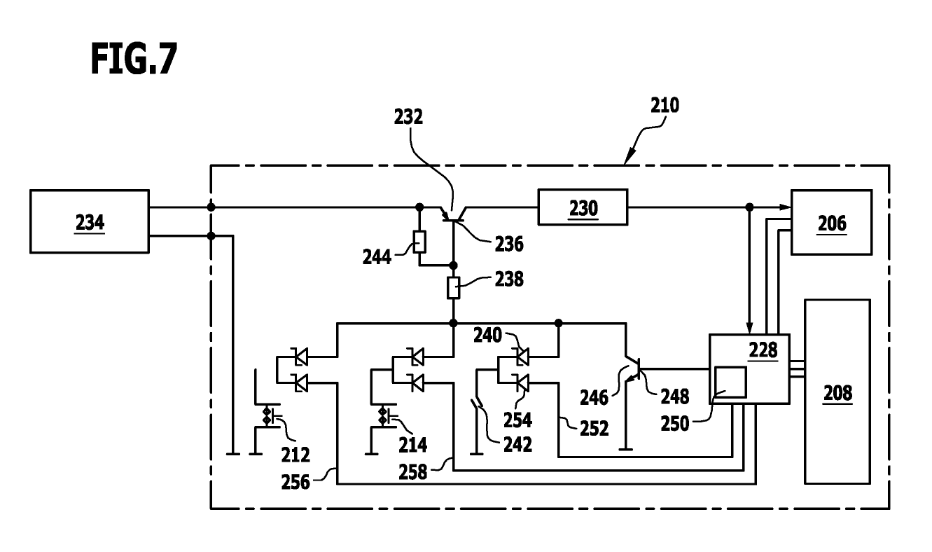

A schematic block diagram of the electric apparatus 202 is shown in FIG. 7. In a corresponding manner to the above-explained electric apparatus 100, the electric apparatus 202 also has a microcontroller 228 and a voltage transformer 230. Via a switching transistor 232, the voltage transformer 230 is connected to the positive pole of a battery 234. A control input 236 of the switching transistor 232 is, via a first ohmic resistor 238 and a Schottky diode 240 series-connected to the first ohmic resistor 238, in electric connection with a reed switch 242 which is connected to an earth potential. Via a second ohmic resistor 244, the control input 236 of the switching transistor 232 is connected to the positive pole of the battery 234. When the first permanent magnet 62 of the spray gun 200 is pivoted by the user by actuating the hand lever 48 from its rest position into its activation position, it approaches the reed switch 242 arranged in the electric casing 204, so that this switch assumes its closed switching position. The closing of the reed switch 242 has the result that, via the two ohmic resistors 238, 244 and the Schottky diode 240, a current can flow, which leads to a corresponding voltage drop, so that the switching transistor 232 switches through and thereby frees the electric connection between the positive pole of the battery 234 and the input of the voltage transformer 230. Via the voltage transformer 230, the microcontroller 228 is supplied with electric energy.

In contrast to the above-explained electric apparatus 100, the electric apparatus 202 has, in addition to the reed switch 242, a self-locking member in the form of a second switching transistor 246 whose control input 248 is connected to the microcontroller 228. In a corresponding manner to the reed switch 242, the second switching transistor 246 also enables the control input 236 of the first switching transistor 232 to be connected to earth potential, so that the first switching transistor 232 can be switched through not only by closing the reed switch 242 but also by controlling the second switching transistor 246.

The second switching transistor 246 provides the microcontroller 228 with the possibility of still maintaining the usable operating mode of the electric apparatus 202, after the opening of the reed switch 242, for a predetermined period of time. For this purpose, the microcontroller 228 has a timer 250 which is activated when the reed switch opens 242. For this purpose, the reed switch 242 is connected via a first input line 252 to the microcontroller 228, a second Schottky diode 254 being connected to the first input line 252. The opening of the reed switch 242 can thus be detected by the microcontroller 228. This has the result that the timer 250 is started, so that the electric connection between the battery 234 and the current consumers of the electric apparatus 202 is still maintained for a predetermined period of time, which may amount to several seconds or even several minutes. After the predetermined period of time has elapsed, the second switching transistor 246 closes and this in turn has the result that the first switching transistor 232 interrupts the electric connection between the positive pole of the battery 234 and the input of the voltage transformer 230. The electric apparatus 202 thus automatically assumes its standby mode after the predetermined period of time has elapsed.

As already mentioned, an activation of the usable operating mode of the electric apparatus 202 can be carried out not only by means of the first permanent magnet 62 but also by actuating the input key 212 or the input key 214. As is apparent from FIG. 7, the input keys 212, 214 enable a connection of the control input 236 of the first switching transistor 232 to earth potential in the same way as the reed switch 242. If, instead of the reed switch 242, one of the input keys 212, 214 is closed, this also results in the first switching transistor 232 freeing the electric connection between the positive pole of the battery 234 and the input of the voltage transformer 230, so that the electric apparatus 202 changes into its usable operating mode. The input key 212 is connected via a second input line 256 to the microcontroller 228, and the input key 214 is connected via a third input line 258 to the microcontroller 228. Via the second input line 256 and the third input line 258, the microcontroller 228 thus receives a signal which indicates to it which input key was actuated. When the input key is released again, this is detected by the microcontroller 228 based on the signal transmitted via the respective input line 256, 258 and then the timer 250 can be activated in the same way as on the opening of the reed switch 242, so that the usable operating mode of the electric apparatus 202 is still maintained for a predetermined period of time.

The electric apparatus 202 may be preassembled in the same way as the electric apparatus 100, the electric casing 202 is configured sealed against sprayed water and can be mounted during the assembly of the spray gun 200 in a simple manner on the gun casing 12 of the spray gun 200. The electric apparatus 202 also has a very low energy consumption, since the current consumers of the electric apparatus 202 are only supplied with electric energy when a use of the spray gun 200 takes place.

1. A spray gun for a high-pressure cleaning appliance, with a gun casing, in which there is arranged a valve, wherein the valve has a through duct which extends from a valve inlet to a valve outlet, and wherein the valve has a closure body which, in a closed position, bears in a fluid-tight manner against a valve seat and which is adapted to be moved, with the aid of a hand lever mechanically coupled to the closure body, into an open position spaced apart from the valve seat, and with an electric apparatus which has an electric display device and at least one battery, wherein the electric apparatus has an electric casing which is sealed against sprayed water and forms a sub-unit which is adapated be handled independently, wherein all of the current-carrying components of the spray gun are arranged in the electric casing and are separated galvanically from the remaining components of the spray gun.

2. The spray gun according to claim 1, wherein the electric casing is releasably mechanically connectable to the gun casing.

3. The spray gun according to claim 1, wherein the electric apparatus has a standby mode and a usable operating mode, wherein the energy consumption of the electric apparatus in the standby mode is lower than in the usable operating mode, and wherein the usable operating mode is activatable by the user and when the spray gun is not in use the electric apparatus changes automatically into the standby mode at the latest after a predetermined period of time has elapsed.

4. The spray gun according to claim 3, wherein the spray gun has at least one activation member movable by the user for activating the usable operating mode.

5. The spray gun according to claim 4, wherein at least one activation member is arranged outside the electric casing in the gun casing and is movable back and forth between a rest position and an activation position, wherein the usable operating mode is wirelessly activatable by moving the activation member (62) from the rest position into the activation position.

6. The spray gun according to claim 5, wherein the activation member arranged outside the electric casing is wirelessly coupled in its activation position to a switching or sensor element of the electric apparatus and the coupling is interrupted in the rest position of the activation member.

7. The spray gun according to claim 4, wherein the usable operating mode is only active when the at least one activation member is in its activation position.

8. The spray gun according to claim 4, wherein, after a change of the activation member from the activation position into the rest position, the usable operating mode is still active until a predetermined time period has elapsed.

9. The spray gun according to claim 4, wherein the activation member arranged outside the electric casing is coupled to the hand lever.

10. The spray gun according to claim 9, wherein the activation member arranged outside the electric casing is rigidly connected to the hand lever.

11. The spray gun according to claim 4, wherein the activation member arranged outside the electric casing is coupled in the activation position magnetically, inductively, capacitively, optically, piezo-electrically or electromagnetically to a switching or sensor element of the electric apparatus.

12. The spray gun according to claim 11, wherein the activation member arranged outside the electric casing is a permanent magnet and in that the switching element is magnetic field-sensitive.

13. The spray gun according to claim 12, wherein the switching element is configured as a reed switch.

14. The spray gun according to claim 4, wherein at least one activation member is configured as a manually actuatable input element of the electric apparatus.

15. The spray gun according to claim 14, wherein the electric apparatus has at least two manually actuatable input elements which each form an activation member.

16. The spray gun according to claim 3, wherein the standby mode is a rest state in which the electric apparatus does not consume energy.

17. The spray gun according to claim 3, wherein in the standby mode, the transmission of electric energy from the battery to all current consumers of the electric apparatus is interrupted.

18. The spray gun according to claim 1, wherein the spray gun has a pressure detecting device for detecting the fluid pressure prevailing downstream of the valve seat in the through duct, wherein the pressure detecting device is arranged outside the electric casing in the gun casing and is wirelessly coupled to a sensor element of the electric apparatus arranged in the electric casing.

19. The spray gun according to claim 18, wherein the pressure detecting device is magnetically, inductively, capacitively, optically, piezo-electrically or electromagnetically coupled to the sensor element.

20. The spray gun according to claim 18, wherein the sensor element is magnetic field-sensitive and wherein the pressure detecting device has a permanent magnet whose spacing from the sensor element is variable in dependence on the fluid pressure prevailing downstream of the valve seat in the through duct.

21. The spray gun according to claim 20, wherein the permanent magnet is rigidly connected to a push part, which is displaceable against an elastic restoring force in dependence on the fluid pressure in a guide part prevailing downstream of the valve seat in the through duct.

22. The spray gun according to claim 21, wherein the push part is rigidly connected to a measuring member, which is adapted to be acted upon by the fluid pressure prevailing downstream of the valve seat in the through duct.

23. The spray gun according to claim 1, wherein one of a plurality of pressure ranges can be visually displayed on the display device in dependence on the pressure prevailing downstream of the valve seat in the through duct.

24. The spray gun according to claim 1, wherein at least one recommendation, dependent on the pressure of the fluid, for a spray nozzle can be displayed on the display device.

25. The spray gun according to claim 1, wherein the display device has a plurality of visual display elements.

26. The spray gun according to claim 1, wherein the display device has a liquid crystal display.

27. The spray gun according to claim 1, wherein the electric apparatus has a transmitting device for wireless transmission of signals from the electric apparatus to the high-pressure cleaning appliance.

28. The spray gun according to claim 1, wherein the electric apparatus has a receiving device for wireless transmission of signals from the high-pressure cleaning appliance to the electric apparatus.

29. The spray gun according to claim 1, wherein the electric apparatus has a transceiver.

30. The spray gun according to claim 1, wherein on the display device a plurality of cleaning parameter ranges can be visually displayed and a desired cleaning parameter range can be selected by the user, wherein the desired cleaning parameter range can be wirelessly transmitted from the electric apparatus to the high-pressure cleaning appliance.

31. The spray gun according to claim 1, wherein the electric apparatus has at least one input element for inputting and/or selecting a control command.

32. The spray gun according to claim 31, wherein the electric apparatus has a rigid printed circuit board, on which the at least one input element and the electric display device are arranged, wherein the at least one input element is coupled to an operating element which has a user-operable interface, wherein the user interface is inclined to a plane which is defined by the display device.

33. The spray gun according to claim 32, wherein the at least one input element is configured as an input key which is adapted to be acted upon with an actuation force by an associated operating element.

34. The spray gun according to claim 32, wherein the at least one operating element is configured as a force diverting element which is movably mounted on the electric casing.

35. The spray gun according to claim 34, wherein the force diverting element is configured as a tumbler.

36. The spray gun according to claim 32, wherein the spray gun has a handle which is adapted to be gripped by the user, and wherein the at least one user interface is arranged at an end of the handle facing the display device.
